(19) United States
(12) Patent Application Publication
(10) Pub. No.: US 2019/0023216 A1
(43) Pub. Date: Jan. 24, 2019

(54) SEAT ASSEMBLIES INCLUDING INTEGRATED AIRBAG DOORS FOR MOTOR VEHICLES

(71) Applicant: GM GLOBAL TECHNOLOGY OPERATIONS LLC, Detroit, MI (US)

(72) Inventors: Rami Z. Sayed, Farmington Hills, MI (US); Carl H. Jarema, Plymouth, MI (US)

(73) Assignee: GM GLOBAL TECHNOLOGY OPERATIONS LLC, Detroit, MI (US)

(21) Appl. No.: 15/657,784

(22) Filed: Jul. 24, 2017

(51) Int. Cl. B60R 21/2165; B60R 21/207; B60R 21/231; B60N 2/58

(52) U.S. Cl. CPC B60R 21/2165; B60R 21/207; B60R 2021/161; B60N 2/58; B60R 2021/23146; B60R 21/23138

(57) ABSTRACT

Seat assemblies for motor vehicles and methods for fabricating such seat assemblies are provided. In one example, a seat assembly for a motor vehicle includes a seat frame and a seat back panel that is coupled to the seat frame. The seat back panel has a frangible tear seam that defines an integrated airbag door. An airbag is disposed between the seat frame and the seat back panel adjacent to the integrated airbag door. The airbag inflates during deployment. The integrated airbag door is configured to open during deployment to allow the airbag to inflate outside of the seat back panel.

### TECHNICAL FIELD

The technical field generally relates to seat assemblies for motor vehicles, and more particularly relates to seat assemblies including a seat back panel with an integrated airbag door for motor vehicles and methods for fabricating such seat assemblies.

### INTRODUCTION

Motor vehicles often include an inflatable restraint apparatus having a deployable airbag positioned to protect an occupant of the motor vehicle. Some seat assemblies for motor vehicles include such an inflatable restraint apparatus. These seat assemblies are typically equipped with an inflatable restraint apparatus that includes an airbag and airbag door assembly that is externally mounted to an outboard side portion of the seat assembly. However, because the externally mounted airbag and airbag door assembly protrudes from the outboard side of the seat assembly towards the adjacent sidewall of the motor vehicle, packaging of the inflatable restraint apparatus within this limited space can be challenging. Moreover, the externally mounted airbag and airbag door assembly is conspicuously visible to the motor vehicle occupants which may be aesthetically undesirable.

Accordingly, it is desirable to provide seat assemblies for motor vehicles equipped with an inflatable restraint apparatus that may be efficiently packaged and/or that may be inconspicuous to an occupant of the motor vehicle. Furthermore, other desirable features and characteristics will become apparent from the subsequent detailed description and the appended claims, taken in conjunction with the accompanying drawings and the foregoing technical field and background.

### SUMMARY

Seat assemblies for motor vehicles and methods for fabricating such seat assemblies are provided herein. In one embodiment, a seat assembly for a motor vehicle includes a seat frame and a seat back panel that is coupled to the seat frame. The seat back panel has a frangible tear seam that defines an integrated airbag door. An airbag is disposed between the seat frame and the seat back panel adjacent to the integrated airbag door. The airbag inflates during deployment. The integrated airbag door is configured to open during deployment to allow the airbag to inflate outside of the seat back panel.

Also in one embodiment, the airbag is supported by the seat frame.

Also in one embodiment, a chute section is disposed adjacent to the airbag and is configured for directing the airbag towards the integrated airbag door during deployment.

Also in one embodiment, the chute section is coupled to the seat frame.

Also in one embodiment, the chute section is coupled to the seat back panel.

Also in one embodiment, the chute section is directly coupled to the seat back panel by one of molding, welding, or heat staking,

Also in one embodiment, the seat back panel has a nominal wall stock thickness and the frangible tear seam is defined by a reduced wall stock section having a thickness less than the nominal wall stock thickness.

Also in one embodiment, the frangible tear seam has a forward in-vehicle seam section and a rearward in-vehicle seam section, and wherein during deployment the integrated airbag door opens along the forward in-vehicle seam section and remains hingedly coupled to the seat back panel by the rearward in-vehicle seam section.

Also in one embodiment, the thickness of the forward in-vehicle seam section is from about 10% to about 30% of the nominal wall stock thickness.

Also in one embodiment, the thickness of the rearward in-vehicle seam section is from about 40% to about 60% of the nominal wall stock thickness.

Also in one embodiment, the seat back panel has an inner surface that is disposed adjacent to the airbag and an outer surface that is on a side opposite the inner surface, and wherein the frangible tear seam defines a recess formed in the inner surface of the seat back panel.

Also in one embodiment, the seat back panel has an inner surface that is disposed adjacent to the airbag and an outer surface that is on a side of the seat back panel opposite the inner surface, and wherein the frangible tear seam defines a recess formed in the outer surface of the seat back panel.

Also in one embodiment, a seat front trim cover has an outboard side and is coupled to the seat back panel, wherein the integrated airbag door is configured to open during deployment to allow the airbag to inflate outside of the seat back panel along the outboard side of the seat front trim cover.

In one embodiment, a seat assembly for a motor vehicle includes a seat front trim cover that has an outboard side. A seat back panel is coupled to the seat front trim cover and has a frangible tear seam that defines an integrated airbag door. An airbag is covered by the seat back panel and is disposed adjacent to the integrated airbag door. The airbag inflates during deployment. The integrated airbag door is configured to open during deployment to allow the airbag to inflate outside of the seat back panel along the outboard side of the seat front trim cover.

Also in one embodiment, the seat back panel has a forward in-vehicle edge portion and the seat front trim cover has a rearward in-vehicle edge portion that is coupled to the forward in-vehicle edge portion of the seat back panel.

Also in one embodiment, a chute section is disposed adjacent to the airbag and is configured for directing the airbag towards the integrated airbag door during deployment.

Also in one embodiment, the chute section is coupled to the seat back panel between the integrated airbag door and the forward in-vehicle edge portion of the seat back panel.

Also in one embodiment, the frangible tear seam has a forward in-vehicle seam section and a rearward in-vehicle seam section, and wherein during deployment the integrated airbag door opens along the forward in-vehicle seam section and remains hingedly coupled to the seat back panel by the rearward in-vehicle seam section.

Also in one embodiment, the forward in-vehicle seam section is disposed between the rearward in-vehicle seam section and the forward in-vehicle edge portion of the seat back panel.

In one embodiment, a method for fabricating a seat assembly for a motor vehicle is provided. The method includes arranging an airbag between a seat frame and a seat back panel adjacent to an integrated airbag door that is formed in the seat back panel. The seat back panel, the airbag, or a combination thereof is supported with the seat frame.

### BRIEF DESCRIPTION OF THE DRAWINGS

The exemplary embodiments will herein be described in conjunction with the following drawing figures, wherein like numerals denote like elements, and wherein:

FIG. 1 illustrates, in a side view, a seat assembly in accordance with an embodiment;

FIG. 2 illustrates, in a perspective view, a portion of a seat back panel in accordance with an exemplary embodiment;

FIG. 3 illustrates a cross-sectional view of the seat assembly depicted in FIG. 1 along line 3-3; and

FIG. 4 illustrates a method for fabricating a seat assembly in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Various embodiments contemplated herein relate to seat assemblies for motor vehicles including an inflatable restraint apparatus and methods for fabricating such seat assemblies. In an exemplary embodiment, the seat assembly includes a seat frame that supports a seat front trim cover and a seat back panel that wraps around at least a portion of the outboard side of the seat assembly. The seat back panel has a frangible tear seam that defines an integrated airbag door, for example, in the outboard side portion of the seat back panel.

An airbag is disposed inside the seat assembly between the seat frame and the seat back panel adjacent to the integrated airbag door. The airbag is configured to inflate when deployed, for example, during a vehicle impact event. As will be discussed in further detail below, the frangible tear seam is configured to rupture, for example, during the airbag deployment to allow the integrated airbag door to open, thereby forming an opening in the seat back panel to allow the airbag to deploy through the seat back panel and inflate outside of the panel.

In an exemplary embodiment, it has been found that by integrating the airbag deployment door into the seat back panel and the airbag into the seat assembly behind the seat back panel, additional packaging space outside of the seat assembly is not needed for accommodating the airbag and airbag door arrangement. Further, the airbag and airbag door arrangement is not conspicuously visible to the occupants of the motor vehicle since the inflatable safety restraint system has been incorporated inside the seat assembly.

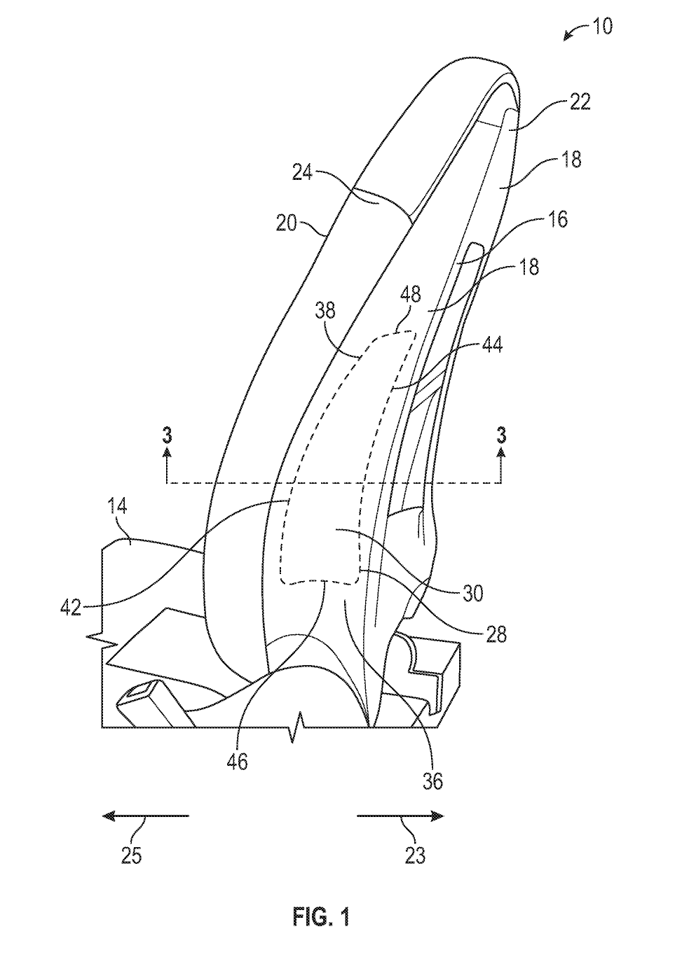

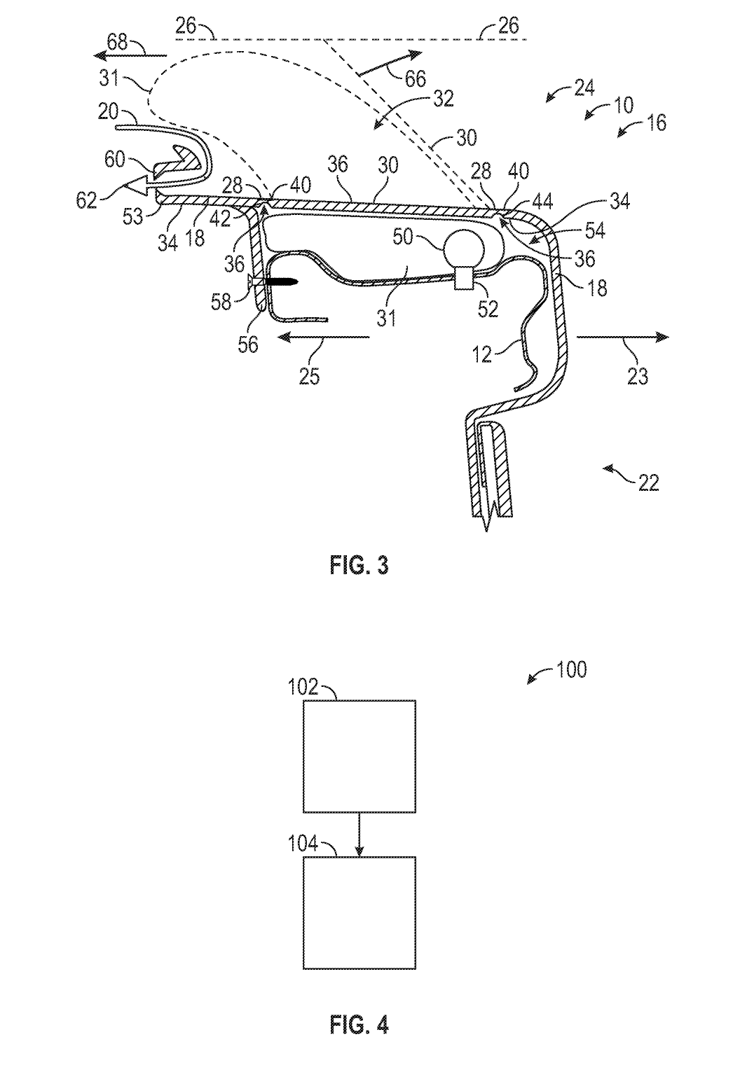

FIG. 1 illustrates, in a side view, a seat assembly 10 for a motor vehicle in accordance with an exemplary embodiment. FIG. 3 illustrates a cross-sectional view of the seat assembly 10 depicted in FIG. 1 along line 3-3. Referring to FIGS. 1 and 3, the seat assembly 10 includes a seat frame 12 for supporting the seat assembly 10. As illustrated, the seat assembly 10 includes a seat portion 14 and a backrest portion 16 that may be pivotably coupled to the seat portion 14 via the seat frame 12, for example, for movement between a substantially upright seat position and a substantially inclined seat position (e.g., forward and/or backward inclined seat position).

In the backrest portion 16 of the seat assembly 10, the seat frame 12 supports a seat back panel 18 (e.g., outer exposed seat backrest panel) and a seat front trim cover 20 (e.g., seat front covering assembly or cushion assembly). As illustrated, the seat back panel 18 may extend partially or fully along a backside 22 of the seat assembly 10 facing in a rearward in-vehicle direction (indicated by arrow 23) and wraps around at least a portion of an outboard side 24 of the seat assembly 10 adjacent to a sidewall structure 26 of the motor vehicle towards a forward in-vehicle direction (indicated by arrow 25). As used herein, the phase “seat back panel” is understood to mean an outer seat trim panel that is arranged rearward in vehicle relative to the seat front trim cover 20 and may or may not extend partially or fully along the backside 22 of the seat assembly 10.

In an exemplary embodiment, the seat back panel 18 includes a relatively rigid panel. The relatively rigid panel may be formed of a relatively rigid thermoplastic material such as polypropylene, thermoplastic olefin (TPO), ABS, polycarbonate, nylon, polyester, or any other suitable interior trim material. The relatively rigid panel may have a decorative hard surface, such as a mold-in-color surface, a painted surface, or the like. Alternatively, the relatively rigid panel may be decorated with a relatively soft covering material, such as leather, cloth or textile fabric (e.g., woven or knitted construction), thermoplastic skin material such as TPO, PVC, or the like, a bi-laminate or tri-laminate including a foam layer covered by a soft skin material layer, or any other suitable interior trim outer flexible and/or soft skin material.

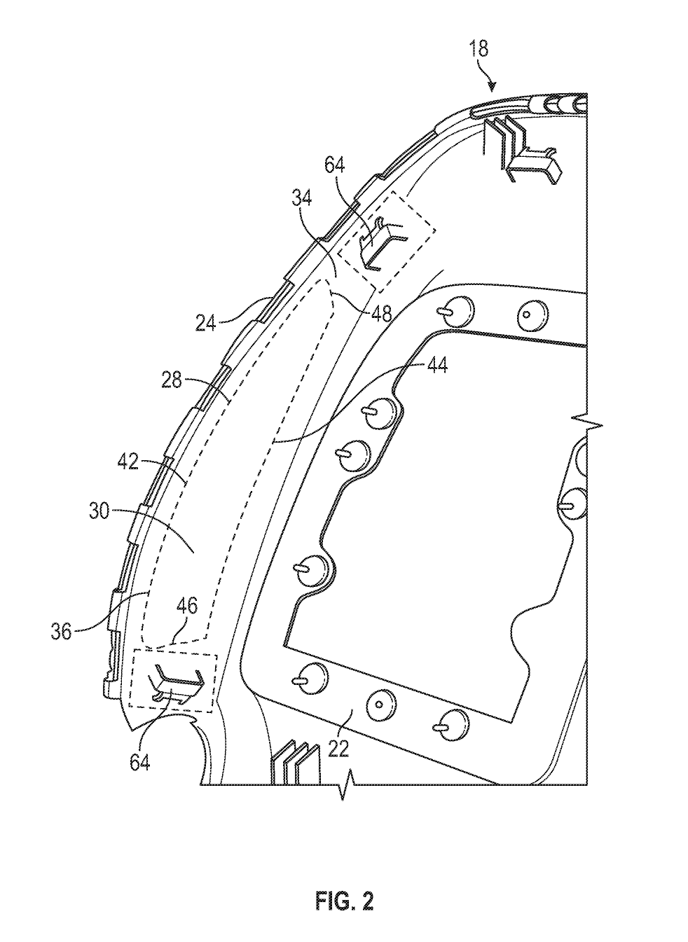

Referring also to FIG. 2, in an exemplary embodiment, the seat back panel 18 has been scored or pre-weakened to form a frangible tear seam 28 that defines an integrated airbag door 30. An airbag 31 is disposed between the seat frame 12 and the seat back panel 18 adjacent to the integrated airbag door 30. As will be discussed in further detail below, the frangible tear seam 28 is configured to rupture during an airbag deployment to allow the integrated airbag door 30 to open, thereby forming an opening 32 in the seat back panel 18 to allow the airbag 31 to inflate outside of the seat back panel 18.

The seat back panel 18 has an inner surface 34 facing towards the inside of the seat assembly 10 and an outer surface 36 that is on a side opposite the inner surface 34 (e.g., outer exposed surface). As illustrated in FIGS. 2 and 3, in an exemplary embodiment, the frangible tear seam 28 is defined by a recess 38 (or recesses) formed in the inner surface 34 of the seat back panel 18. Alternatively, the frangible tear seam 28 may be defined by the recess 38 (or recesses) formed in the outer surface 36 (schematically illustrated as a dashed line in FIG. 1) of the seat back panel 18.

In an exemplary embodiment, the seat back panel 18 has a nominal wall stock thickness and the recess(es) 38 is defined by a reduced wall stock section 40 having a thickness less than the nominal wall stock thickness. In one embodiment, the nominal wall stock thickness of the seat back panel 18 is from about 2 to about 4 mm such as from about 2.5 to about 3 mm and the thickness of the reduced wall stock section 40, which may be continuous or discontinuous and/or vary or be relatively constant, is from about 0.2 to about 2 mm.

As illustrated, the frangible tear seam 28 forms a substantially rectangular shape that is long in the vertical direction. The vertical seam sections of the frangible tear seam 28 include a forward in-vehicle seam section 42 and a rearward in-vehicle seam section 44 that are connected by lower and upper seam sections 46 and 48. In an exemplary embodiment and as will be discussed in further detail below, during deployment of the airbag 31, the in-seam section 42 and the lower and upper seam sections 46 and 48 rupture to allow the integrated airbag door 30 to open while the rearward in-vehicle seam section 44 functions as a hinge to allow the integrated airbag door 30 to remain hingedly coupled to the seat back panel 18. In one example, the thickness of the forward in-vehicle seam section 42 is from about 10% to about 30%, such as about 20%, of the nominal wall stock thickness, and independently, the thickness of the rearward in-vehicle seam section 44 is from about 40% to about 60%, such as about 50%, of the nominal wall stock thickness. Although the integrated airbag door 30 is shown as having a substantially rectangular shape, it is to be understood that other seam configurations for pre-weakening the seat back panel 18 to form the integrated airbag door 30 with different shapes may be used.

In an exemplary embodiment, the frangible tear seam 28 may be formed using a laser scoring process. In one example, the frangible tear seam 28 is formed by radiating a laser beam on the surface (e.g., inner surface 34) of the seat back panel 18 to create dot-like slit pores (e.g., recesses 38) having a depth that partially penetrates the seat back panel 18. Alternatively, the frangible tear seam 28 may be formed by molding in the recess or recesses 38 during injection molding of the seat back panel 18, or by using a post molding mechanical scoring process or any other substrate pre-weakening process known to those skilled in the art.

In an exemplary embodiment, an inflator 50 (e.g., gas generator) is in fluid communication with the airbag 31. In one example, the inflator 50 is disposed inside of the airbag 31 and has one or more attachment features 52 that extend from the inflator 50 through a portion of the airbag 31. The seat frame 12 defines a stowage space 54 for housing the airbag 31. The one or more attachment features 52 from the inflator 50 are coupled to the seat frame 12 adjacent to the stowage space 54 to support and couple the airbag 31 to the seat frame 12.

In an exemplary embodiment, the seat back panel 18 has a forward in-vehicle edge portion 53 and the seat front trim cover 20 has a rearward in-vehicle edge portion 55 that is coupled to the forward in-vehicle edge portion 53 of the seat back panel 18. In one non-limiting example, the forward in-vehicle edge portion 53 of the seat back panel 18 has one or more negative features 60 (e.g., hole(s), opening(s), or the like) and the rearward in-vehicle edge portion 55 of the seat front trim cover 20 has one or more positive feature 62 that engage (e.g., snap fit or the like) the one or more negative features 60 to couple the seat back panel 18 to the seat front trim cover 20. In an exemplary embodiment, attaching the forward in-vehicle edge portion 53 of the seat back panel 18 to the front trim cover 20 helps to stabilize the portion of the seat back panel 18 along the outboard side 24 that includes the integrated airbag door 30 to advantageously facilitate a clean airbag deployment (e.g., inflated airbag with minimal or no fragmentation from surrounding components).

A chute section 56 is disposed adjacent to the airbag 31 and the stowage space 54 and is configured for directing the airbag 31 towards the integrated airbag door 30 during deployment. As illustrated, the chute section 56 is coupled to the seat back panel 18 between the integrated airbag door 30 and the forward in-vehicle edge portion 53 of the seat back panel 18. In one example, the chute section 56 is directly coupled to the seat back panel 18, for example, as an integrally molded section of the seat back panel 18, or alternatively, as a separate component that is welded or heat staked to the seat back panel 18.

The chute section 56 extends from the inner surface 34 of the seat back panel 18 towards the seat frame 12. The chute section 56 is coupled to the seat frame 12 adjacent to the stowage space 54 via one or more attachment features 58. Additionally, the seat frame 12 may be secured to attachment features 64 of the seat back panel 18 below and above the lower and upper seam sections 46 and 48, respectively, of the integrated airbag door 30. As such, in an exemplary embodiment, the airbag 31 is securely and tightly packaged within the stowage space 54 with the portions of the seat back panel 18 adjacent to the forward in-vehicle seam section 42, the lower seam section 46, and the upper seam section 48 securely fastened directly or indirectly to the seat frame 12 such that when the airbag 31 is deployed, energy from the expanding airbag 31 is focused or concentrated on the seam sections 42, 46, and 48 to facilitate a clean opening of the integrated airbag door 30.

In an exemplary embodiment, during a vehicle impact event, a signal is provided to the inflator 50 to generate an inflation gas to inflate the airbag 31 for deployment. As the airbag 31 begins to expand, the airbag 31 pushes against the inner surface 34 of the integrated airbag door 30. The resulting stresses produced along the integrated airbag door 30 are focus or concentrated at the seam sections 42, 46, and 48, thereby rupturing the seam sections 42, 46, and 48 so that the integrated airbag door 30 opens in a direction (indicated by single headed arrow 66) generally towards the rearward in-vehicle direction 23 to form the opening 32 in the seat back panel 18. As discussed above, the rearward in-vehicle seam section 44 functions as a hinge so that the integrated airbag door 30 remains attached to the seat back panel 18. The airbag 31 continues to inflate through the opening 32 and outside of the seat back panel 18 between the outboard side 24 of the seat front trim cover 20 and the sidewall structure 26 of the motor vehicle in a direction (indicated by single headed arrow 68) generally towards the forward in-vehicle direction 25 to be positioned to help protect an occupant of the motor vehicle that is in the seat assembly 10.

Referring to FIG. 4, a method 100 for fabricating a seat assembly for a motor vehicle is provided. The method 100 includes arranging (step 102) an airbag between a seat frame and a seat back panel adjacent to an integrated airbag door that is formed in the seat back panel. The seat back panel, the airbag, or a combination thereof is supported (step 104) with the seat frame.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A seat assembly for a motor vehicle, the seat assembly comprising:
a seat frame;
a seat back panel coupled to the seat frame and having a frangible tear seam that defines an integrated airbag door; and
an airbag that is disposed between the seat frame and the seat back panel adjacent to the integrated airbag door and that inflates during deployment, wherein the integrated airbag door is configured to open during deployment to allow the airbag to inflate outside of the seat back panel.

2. The seat assembly of claim 1, wherein the airbag is supported by the seat frame.

3. The seat assembly of claim 1, further comprising a chute section that is disposed adjacent to the airbag and that is configured for directing the airbag towards the integrated airbag door during deployment.

4. The seat assembly of claim 3, wherein the chute section is coupled to the seat frame.

5. The seat assembly of claim 3, wherein the chute section is coupled to the seat back panel.

6. The seat assembly of claim 5, wherein the chute section is directly coupled to the seat back panel by one of molding, welding, or heat staking.

7. The seat assembly of claim 1, wherein the seat back panel has a nominal wall stock thickness and the frangible tear seam is defined by a reduced wall stock section having a thickness less than the nominal wall stock thickness.

8. The seat assembly of claim 7, wherein the frangible tear seam has a forward in-vehicle seam section and a rearward in-vehicle seam section, and wherein during deployment the integrated airbag door opens along the forward in-vehicle seam section and remains hingedly coupled to the seat back panel by the rearward in-vehicle seam section.

9. The seat assembly of claim 8, wherein the thickness of the forward in-vehicle seam section is from about 10% to about 30% of the nominal wall stock thickness.

10. The seat assembly of claim 8, wherein the thickness of the rearward in-vehicle seam section is from about 40% to about 60% of the nominal wall stock thickness.

11. The seat assembly of claim 1, wherein the seat back panel has an inner surface that is disposed adjacent to the airbag and an outer surface that is on a side opposite the inner surface, and wherein the frangible tear seam defines a recess formed in the inner surface of the seat back panel.

12. The seat assembly of claim 1, wherein the seat back panel has an inner surface that is disposed adjacent to the airbag and an outer surface that is on a side of the seat back panel opposite the inner surface, and wherein the frangible tear seam defines a recess formed in the outer surface of the seat back panel.

13. The seat assembly of claim 1, further comprising a seat front trim cover that has an outboard side and that is coupled to the seat back panel, wherein the integrated airbag door is configured to open during deployment to allow the airbag to inflate outside of the seat back panel along the outboard side of the seat front trim cover.

14. A seat assembly for a motor vehicle, the seat assembly comprising:
a seat front trim cover having an outboard side;
a seat back panel coupled to the seat front trim cover and having a frangible tear seam that defines an integrated airbag door; and
an airbag that is covered by the seat back panel and disposed adjacent to the integrated airbag door and that inflates during deployment, wherein the integrated airbag door is configured to open during deployment to allow the airbag to inflate outside of the seat back panel along the outboard side of the seat front trim cover.

15. The seat assembly of claim 14, wherein the seat back panel has a forward in-vehicle edge portion and the seat front trim cover has a rearward in-vehicle edge portion that is coupled to the forward in-vehicle edge portion of the seat back panel.

16. The seat assembly of claim 15, further comprising a chute section that is disposed adjacent to the airbag and that is configured for directing the airbag towards the integrated airbag door during deployment.

17. The seat assembly of claim 16, wherein the chute section is coupled to the seat back panel between the integrated airbag door and the forward in-vehicle edge portion of the seat back panel.

18. The seat assembly of claim 15, wherein the frangible tear seam has a forward in-vehicle seam section and a rearward in-vehicle seam section, and wherein during deployment the integrated airbag door opens along the forward in-vehicle seam section and remains hingedly coupled to the seat back panel by the rearward in-vehicle seam section.

19. The seat assembly of claim 18, wherein the forward in-vehicle seam section is disposed between the rearward in-vehicle seam section and the forward in-vehicle edge portion of the seat back panel.

20. A method for fabricating a seat assembly for a motor vehicle, the method comprising the steps of:
arranging an airbag between a seat frame and a seat back panel adjacent to an integrated airbag door that is formed in the seat back panel; and
supporting the seat back panel, the airbag, or a combination thereof with the seat frame.
